(19) United States
(12) Patent Application Publication
(10) Pub. No.: US 2018/0058385 A1
(43) Pub. Date: Mar. 1, 2018

(54) FUEL VAPOR PURGE SYSTEM

(71) Applicant: Hyundai Motor Company, Seoul (KR)

(72) Inventor: Choo Saeng CHOI, Seongnam-si (KR)

(73) Assignee: Hyundai Motor Company, Seoul (KR)

(21) Appl. No.: 15/376,549

(22) Filed: Dec. 12, 2016

(30) Foreign Application Priority Data
Aug. 24, 2016 (KR) 10-2016-0107729

(51) Int. Cl. F02M 25/08

(52) U.S. Cl. CPC F02M 25/089; F02M 2025/0845; F02M 25/0836; F02M 25/0872

(57) ABSTRACT

A fuel vapor purge system may include a recirculation line that is branched from an intake line that supplies intake air to an engine to join to the intake line of the rear end portion of a compressor of a turbocharger; an ejector that is integrally formed with a recirculation valve housing that is disposed at a point in which the recirculation line and the intake line join; a first purge line that connects a canister and the intake line; and a second purge line that connects the canister and the ejector.

### CROSS-REFERENCE TO RELATED APPLICATION

The present application claims priority to Korean Patent Application No. 10-2016-0107729 filed on Aug. 24, 2016, the entire contents of which is incorporated herein for all purposes by this reference.

### BACKGROUND OF THE INVENTION

### Field of the Invention

Various embodiments of the present invention relates to a fuel vapor purge system.

### Description of Related art

In order to enhance an exhaust gas, many researches have been performed in a vehicle industry, and particularly, in order to minimize discharge of hydrocarbon (HC) among evaporation gas components of gasoline fuel, foreign countries adapt a regulation that regulates a total amount of a fuel evaporation gas to 0.5 g/day or less and are scheduled to sequentially enlarge a total amount of a fuel evaporation gas to 0.054 g/day or less.

Generally, in order to correspond to the regulation, nowadays, by improving a material of a fuel tank and optimizing a connection structure thereof, occurrence of a fuel evaporation gas that penetrates the fuel tank has been minimized and a fuel evaporation gas recirculation apparatus in which a canister is applied to a fuel supply apparatus has been used.

Here, the canister contains an adsorbent material that can absorb a fuel evaporation gas from a fuel tank that stores volatile fuel, and in order to prevent a fuel evaporation gas that evaporates from a float chamber of a vaporizer and the fuel tank from being discharged to the air, the canister is connected with the fuel tank to collect the fuel evaporation gas.

In this way, the fuel evaporation gas that is collected in the canister is again injected into the engine through a Purge Control Solenoid Valve (PCSV) that is controlled by an Engine Control Unit (ECU) to be burned and thus the fuel evaporation gas is recirculated.

Nowadays, in order to correspond to a reinforcing regulation, various kinds of fuel vapor purge systems have been researched, but because the fuel vapor purge system has a complex configuration, it is difficult to design an internal layout of an engine room and the work number thus increases and thus a problem occurs that a production cost of a vehicle increases.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a fuel vapor purge system having advantages of being configured for having a simple configuration.

The present invention has been made in an effort to further provide a fuel vapor purge system having advantages of being configured for reducing a production cost of a vehicle by reducing the work number of the vehicle through a fuel vapor purge system of a simple configuration.

Various aspects of the present invention are directed to providing a fuel vapor purge system including: a recirculation line that is branched from an intake line that supplies intake air to an engine to join to the intake line of the rear end portion of a compressor of a turbocharger; an ejector that is integrally formed with a recirculation valve housing that is positioned at a point in which the recirculation line and the intake line join; a first purge line that connects a canister and the intake line; and a second purge line that connects the canister and the ejector.

The ejector may include: a trunk portion having a flow channel therein; a first inlet that fluidically-communicates with the flow channel and that fluidically-communicates with an intake line of the rear end portion of the compressor; a second inlet that fluidically-communicates with the flow channel and that fluidically-communicates with the second purge line; and an outlet that fluidically-communicates with the flow channel and that fluidically-communicates with the recirculation line.

The first inlet and the outlet may be located on the same axis along the flow channel, and the second inlet may be located vertically to the flow channel.

A cross-section of the fluid path may gradually increase as advancing to the outlet while gradually decreasing from the first inlet according to fluid flow.

The recirculation valve may be opened when tipped out to discharge a supercharge pressure that is formed at an intake line between the rear end portion of the compressor and the throttle valve to an intake line of the front end of the compressor.

The fuel vapor purge system may further include: a purge control solenoid valve that selectively blocks a fuel vapor that is collected at the canister; a first check valve that is mounted in the first purge line and that blocks a fuel vapor that flows the first purge line from flowing backward; and a second check valve that is mounted in the second purge line and that blocks a fuel vapor that flows the second purge line from flowing backward.

As described above, according to a fuel vapor purge system by an exemplary embodiment of the present invention, by integrally forming an ejector with a recirculation valve housing, a configuration of the fuel vapor purge system can be simplified.

Further, by simplifying a configuration of the fuel vapor purge system, the work number can be reduced and thus a production cost of a vehicle can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a configuration of a fuel vapor purge system according to an exemplary embodiment of the present invention.

FIG. 2 is a partial perspective view illustrating a recirculation valve housing in which an ejector is mounted according to an exemplary embodiment of the present invention.

FIG. 3 is a partially cross-sectional view illustrating a recirculation valve housing in which an ejector is mounted according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of Exemplary embodiments of the present application will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

Further, in the drawings, a size and thickness of each element are randomly represented for better understanding and ease of description, and the present invention is not limited thereto, and the thickness of several portions and areas are exaggerated for clarity.

Hereinafter, a fuel vapor purge system according to an exemplary embodiment of the present invention will be described in detail with reference to the attached drawings.

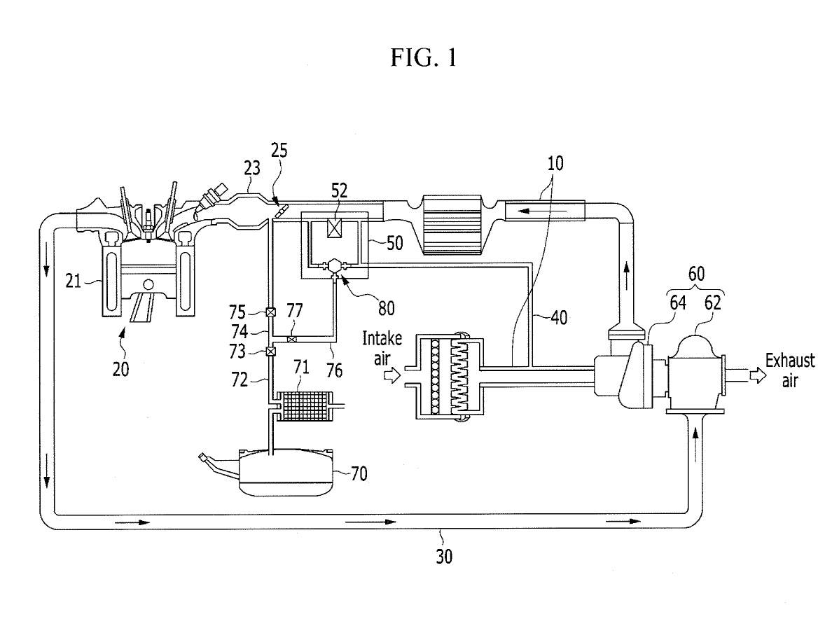

FIG. 1 is a schematic view illustrating a configuration of a fuel vapor purge system according to an exemplary embodiment of the present invention.

As shown in FIG. 1, a fuel vapor purge system according to an exemplary embodiment of the present invention includes a canister 71 that collects a fuel vapor, a purge control solenoid valve 73 for supplying a fuel vapor that is collected in the canister 71 to a cylinder 21 of an engine 20 and the front end of a turbocharger 60, and a recirculation valve 52 that recirculates air that is compressed by a first check valve 75, a second check valve 77, and the turbocharger 60.

The engine 20 includes a plurality of cylinders 21 that generate a driving torque by combustion of fuel. The engine 20 has an intake line 10 in which an intake gas that is supplied to the cylinder 21 flows and an exhaust line 30 in which an exhaust gas that is discharged from the cylinder 21 flows.

Air that is injected through the intake line 10 is supplied to the cylinder 21 through an intake manifold 23. A throttle valve 25 that adjusts an air amount that is supplied to the cylinder 21 is mounted in the intake line 10 of the front end of the intake manifold 23.

The turbocharger 60 operates by an exhaust gas that is discharged from the cylinder 21 to compress and supply to an intake gas (external air mixed with recirculation gas) to the cylinder 21. The turbocharger 60 includes a turbine 62 that is mounted at the exhaust line 30 and that rotates by an exhaust gas that is discharged from the cylinder 21 and a compressor 64 that rotates by interlocking with the turbine 62 and that compresses an intake gas.

A recirculation line 40 that is branched from the intake line 10 of the rear end portion (downstream) of the turbine 62 to join to the intake line 10 of the front end (upstream) of the compressor 64 is provided, and the recirculation valve 52 is mounted at a point in which the recirculation line 40 and the intake line 10 join. Operation of the recirculation valve 52 is configured to be controlled by, for example, an Engine Control Unit (ECU) that is mounted at the vehicle.

The recirculation valve 52 selectively discharges a high pressure that is formed at the front end of the throttle valve 25 from the rear end portion of the compressor 64 to the intake line 10 of the front end of the compressor 64.

For example, while the vehicle accelerates, when a driver tips out, to reduce an output of the engine 20, the ECU blocks the throttle valve 25 to block the output from being supplied to the cylinder 21. In the instant case, in the intake line 10 between the rear end portion of the compressor 64 and the throttle valve 25, a supercharge pressure is formed by the turbocharger 60. Therefore, the ECU controls opening of the recirculation valve 52 to discharge a supercharge pressure that is formed in the intake line 10 between the rear end portion of the compressor 64 and the throttle valve 25 to the intake line 10 of the front end of the compressor 64.

When a supercharge pressure continues at the intake line 10 between the rear end portion of the compressor 64 and the throttle valve 25, when the throttle valve 25 is again opened, a surging impact may occur. Therefore, a supercharge pressure of the intake line 10 is discharged through the recirculation valve 52.

Volatile fuel that is supplied to the cylinder 21 is stored at a fuel tank 70, and the canister 71 is connected with the fuel tank 70 through a vapor line and contains an adsorbent material that can absorb a fuel vapor that has occurred at the fuel tank 70.

The purge control solenoid valve (PCSV) 73 is mounted in a first purge line 74 that is connected with the canister 71 and selectively blocks a fuel vapor that is collected in the canister 71. Operation of the PCSV 73 is configured to be controlled by the ECU. In the instant case, a fuel vapor amount that is discharged through the PCSV 73 is adjusted by the duty control of the ECU.

A main purge line 72 is branched to the first purge line 74 and a second purge line 76.

The first purge line 74 is branched from the main purge line 72 to join to the intake manifold 23 that distributes intake air to the cylinder 21. The first check valve 75 is mounted in the first purge line 74 and blocks a fuel vapor that flows the first purge line 74 from flowing backward.

That is, due to the first check valve 75, a fuel vapor that flows the first purge line 74 flows from the PCSV 73 to the intake manifold 23 but does not flow in an opposite direction.

The second purge line 76 is branched from the main purge line 72 to join to the recirculation valve 52. In the second purge line 76, the second check valve 77 is mounted, and the second check valve 77 blocks a fuel vapor that flows the second purge line 76 from flowing backward.

That is, due to the second check valve 77, a fuel vapor that flows the second purge line 76 flows from the PCSV 73 to an ejector 80 but does not flow in an opposite direction.

In a connection portion of the second purge line 76 and the recirculation valve 52, the ejector 80 that supplies a fuel vapor that flows the second purge line 76 by a boost pressure of the turbocharger 60 to the intake line 10 of the front end of the turbocharger 60 is provided. In the instant case, the ejector 80 is integrally formed with the recirculation valve 52. In this way, as the ejector 80 is integrally formed with the recirculation valve 52, a configuration of a supply line of a fuel vapor that is injected through the second purge line 76 can be simplified.

Specifically, a shape of the ejector 80 will be described.

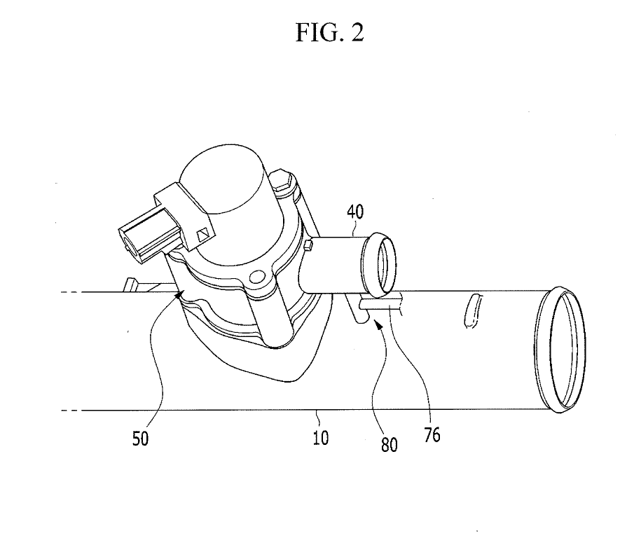

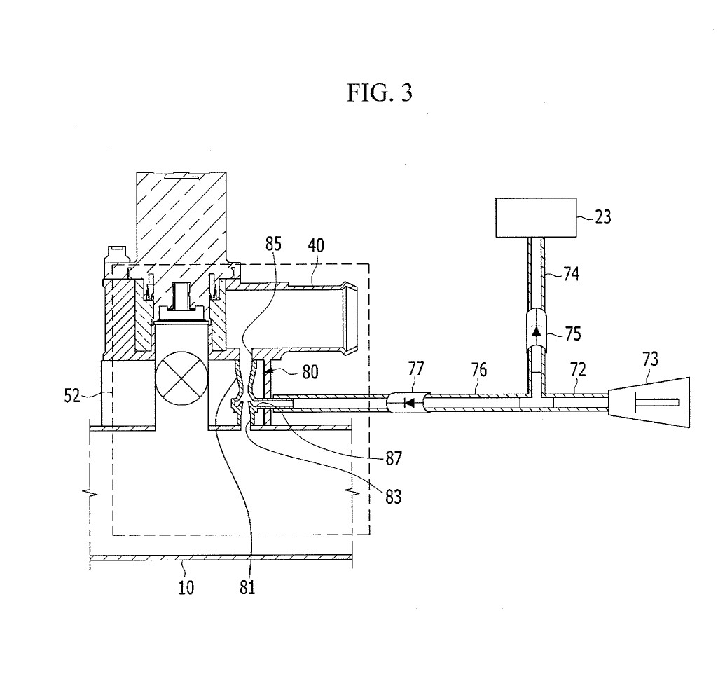

FIG. 2 is a partial perspective view illustrating a recirculation valve housing 50 in which an ejector 80 is mounted according to an exemplary embodiment of the present invention. FIG. 3 is a partially cross-sectional view illustrating a recirculation valve housing 50 in which an ejector 80 is mounted according to an exemplary embodiment of the present invention.

As shown in FIG. 2 and FIG. 3, the ejector 80 includes a trunk portion 81 that is integrally formed with the recirculation valve housing 50, and in the trunk portion 81, a first inlet 83, a second inlet 87, and an outlet 85 are formed.

At the inside of the trunk portion 81, a flow channel for supplying a fuel vapor that is supplied through the second purge line 76 to the intake line 10 of the front end of the compressor 64 is formed.

The first inlet 83 fluidically-communicates with the flow channel and is connected with the intake line 10 of the rear end portion (downstream) of the compressor 64 and thus air that is compressed by the turbocharger 60 through the first inlet 83 may be injected into the flow channel.

The second inlet 87 fluidically-communicates with the flow channel and is connected with the second purge line 76 and thus a fuel vapor that flows the second purge line 76 may be injected into the flow channel.

The outlet 85 fluidically-communicates with the flow channel and is connected with the recirculation line 40 that is connected with an intake line of the front end (upstream) of the compressor 64 and thus a fuel vapor that is injected through the second purge line 76 may be ejected to the intake line 10 of the front end of the compressor 64 through the flow channel by air that is compressed by the turbocharger 60.

It is preferable that the first inlet 83 and the outlet 85 are located on the same axis along the flow channel, and it is preferable that the second inlet 87 is located vertically to the flow channel.

A cross-section of a fluid path that is formed within the ejector 80 gradually increases as advancing to the outlet 85 while gradually decreasing from the first inlet 83 according to flow of a fluid (compressed air mixed with fuel vapor) that flows the flow channel. As the flow channel is formed to gradually increase as advancing to the outlet 85 while gradually decreasing from the first inlet 83 according to fluid flow, a fuel vapor that is injected through the second purge line 76 may be discharged to the outlet 85 by a venture effect.

Hereinafter, operation of a fuel vapor purge system according to the foregoing exemplary embodiment of the present invention will be described in detail.

First, a fuel vapor occurring in the fuel tank 70 is collected by the canister 71.

When a driving area of the engine 20 is not a boosting area, a negative pressure is formed in the intake manifold 23 and thus the first check valve 75 is opened by a negative pressure of the intake manifold 23, a fuel vapor that is collected by the canister 71 is injected into the intake manifold 23 through the first check valve 75 that is mounted in the main purge line 72 and the first purge line 74.

Because the outlet 85 of the ejector 80 fluidically-communicates with the front end of the compressor 64, a pressure of the outlet 85 of the ejector 80 is a same as a front end pressure of the compressor 64. Because the first inlet 83 of the ejector 80 fluidically-communicates with the rear end portion of the compressor 64, a pressure of the first inlet 83 of the ejector 80 is the same as that of the rear end portion of the compressor 64.

Therefore, when the turbocharger 60 operates, a pressure of the first inlet 83 is larger than that of the outlet 85 by a supercharge pressure by the compressor 64 and a negative pressure occurs in a flow channel of the ejector 80 by a venturi effect by a shape of the ejector 80 and thus the second check valve 77 is opened. Therefore, a fuel vapor that flows the second purge line 76 is injected into the second inlet 87 through the PCSV 73 and is injected into the front end of the compressor 64 along a flow channel of the ejector 80. Further, air that is boosted within an intake manifold by the first check valve 75 is blocked and thus air (new air) does not flow to the ejector 80.

While the turbocharger 60 operates, when a driver tips out for deceleration of the vehicle, to lower an output of the engine 20, the ECU quickly closes the throttle valve 25. In the instant case, while the turbocharger 60 operates by inertia, a supercharge pressure occurs by the compressor 64, and in the intake line 10 between the rear end portion of the compressor 64 and the front end of the throttle valve 25, a supercharge pressure is formed by compressed air that has occurred by the compressor 64.

Therefore, the ECU opens the recirculation valve 52 to discharge a supercharge pressure that is formed in the intake line 10 between the rear end portion of the compressor 64 and the front end of the throttle valve 25 to the intake line 10 of the front end of the compressor 64, preventing a surging impact.

In the instant case, because the ejector 80 is integrally formed with a housing of the recirculation valve, a length of a line necessary for the ejector 80 can be minimized and thus a configuration of the fuel vapor purge system can be simplified.

Further, by simplifying a configuration of the fuel vapor purge system, the work number can be reduced and thus a production cost of a vehicle can be reduced.

For convenience in explanation and accurate definition in the appended claims, the terms “upper”, “lower”, “inner” and “outer”, “up,” “down,” “upper”, “lower,” “upwards,” “downwards”, “front”, “rear”, “back”, “inside”, “outside”, “inwardly,” “outwardly,” “interior”, “exterior”, “inner,” “outer”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel vapor purge system, comprising:
a recirculation line that is branched from an intake line that supplies intake air to an engine to join to the intake line of the rear end portion of a compressor of a turbocharger;
an ejector that is integrally formed with a recirculation valve housing that is positioned at a point in which the recirculation line and the intake line join;
a first purge line that connects a canister and the intake line; and
a second purge line that connects the canister and the ejector.

2. The fuel vapor purge system of claim 1, wherein the ejector includes:
a trunk portion having a flow channel therein;
a first inlet that fluidically-communicates with the flow channel and that fluidically-communicates with the intake line of the rear end portion of the compressor;
a second inlet that fluidically-communicates with the flow channel and that fluidically-communicates with the second purge line; and
an outlet that fluidically-communicates with the flow channel and that fluidically-communicates with the recirculation line.

3. The fuel vapor purge system of claim 2, wherein the first inlet and the outlet are located on a same axis along the flow channel, and
the second inlet is located vertically to the flow channel.

4. The fuel vapor purge system of claim 2, wherein a cross-section of the fluid path increases as advancing to the outlet while decreasing from the first inlet according to fluid flow.

5. The fuel vapor purge system of claim 1, wherein the recirculation valve is configured to be opened when tipped out to discharge a supercharge pressure that is formed at an intake line between the rear end portion of the compressor and a throttle valve to an intake line of the front end of the compressor.

6. The fuel vapor purge system of claim 1, further including:
a purge control solenoid valve that selectively blocks a fuel vapor that is collected at the canister;
a first check valve that is mounted in the first purge line and that blocks a fuel vapor that flows the first purge line from flowing backward thereof; and
a second check valve that is mounted in the second purge line and that blocks a fuel vapor that flows the second purge line from flowing backward thereof.
